(19) United States
(12) Patent Application Publication
(10) Pub. No.: US 2023/0077180 A1
(43) Pub. Date: Mar. 9, 2023

(54) ELECTRODE, ENERGY STORAGE DEVICE AND METHOD

(71) Applicant: INSTITUTT FOR ENERGITEKNIKK, Kjeller (NO)

(72) Inventors: Arve Ottar HOLT, Leirsund (NO); Asbjørn ULVESTAD, Oslo (NO); Alexey KOPOSOV, Oslo (NO); Marte Orderud SKARE, Oslo (NO)

(21) Appl. No.: 17/799,304

(22) PCT Filed: Feb. 12, 2021
(86) PCT No.: PCT/EP2021/053506

§ 371 Date: Aug. 12, 2022

(30) Foreign Application Priority Data
Feb. 12, 2020 (NO) 20200176

(51) Int. Cl. H01M 4/134; H01M 10/0525; H01M 4/1395; H01M 10/0567; H01M 4/04

(52) U.S. Cl. CPC H01M 4/134; H01M 10/0525; H01M 4/1395; H01M 10/0567; H01M 4/0404; H01M 2300/0051; H01M 2004/021

(57) ABSTRACT

Electrode for an energy storage device which comprises a powder of particles (26) comprising amorphous, micro- or nano-crystalline coated or uncoated silicon oxynitride having a chemical formula SiNₓO_{y}, where 0.03≤x+y<1.3, whereby nitrogen makes up 10-99% of said x+y value with the balance being oxygen.

### TECHNICAL FIELD

The present invention concerns an electrode comprising a powder of particles comprising amorphous, micro- or nano-crystalline non-stoichiometric silicon oxynitride, a method for producing such an electrode, and an energy storage device, such as a battery; a Li-ion battery for example, which comprises at least one such electrode.

### BACKGROUND OF THE INVENTION

Batteries for electrochemical energy storage can be produced in many ways using various chemistries. Currently, the battery chemistry which has been seeing the fastest growth is the Li-ion battery. The key components of this technology are the electrodes: anode and cathode, the electrolyte connecting the two electrodes internally inside the battery enabling the transport of lithium (Li) ions, the separator preventing an electrical short within the battery and the current collectors providing the external connection. During the charge and discharge of the battery, Li ions diffuse through the electrolyte from the cathode material to the anode material and back. To preserve the electric charge of the battery, a current of electrons is established through the current collectors to balance the transport of the positively charged Li-ion transport.

An electrode usually takes the shape of a porous film comprising the active material that participates in electrochemical interaction with the lithium, a binder ensuring the structural integrity of the electrode and the adhesion of the active material to the current collector, and sometimes a conductive powder like graphite or similar to provide extra electron conductivity within the electrode. The active material can typically be introduced into an electrode processing in the form of a powder.

Silicon (Si) is in general considered to be a very promising anode material for Li-ion batteries due to its very high theoretical Li-absorption capacity of up to 4.4 Li atoms per each Si atom. However, Si expands by up to 400% during the interaction (alloying) with Li, meaning that for each cycle of charging and discharging of the battery, the Si will expand and contract, often at different rates in different parts of the same electrode. This can cause cracking of the Si particles, which exposes a new surface for interactions with the electrolyte and reduces the internal electron conductivity of the particles to the extent that some parts of the particle can become disconnected from the conductive network of the battery electrode. When embedded in a battery electrolyte, a fresh Si surface will react chemically with electrolyte and Li salts to produce a solid-electrolyte-interface (SEI) layer. During the cycling of the battery, this layer has been known to peel off, thereby exposing new fresh surfaces, forming a new SEI-layer and in this way consuming the electrolyte and lithium, both available in a limited supply, and, thus, degrading the battery. In particular, the degradation mechanisms through fracturing the particles will lead to very large fresh surface areas leading to constant SEI-layer formation, and will correspondingly result in a large amount of electrolyte being consumed and degraded. In addition to the reported cracking, the inventors of the present invention have found that fully lithiated silicon seems to become highly mobile, and re-organizes itself into new structures according to the Li flows during lithiation and de-lithiation of the electrodes. This continuously creates additional new surfaces, and after long cycling, the surface to volume ratio of the silicon can rise to extreme values. All processes described above are causes for the failure of anodes based on Si.

Many prior art documents and studies have addressed these problems by coating the Si nanostructures creating core/shell structures. US patent application no. US 2015/280222 discloses that the expansion of Si will however break most coatings applied thereto, leading to fresh Si surfaces being exposed. The high mobility of lithiated Si will then lead to this fresh surface dominating further lithiation, and thereby degradation behavior. Sometimes it is attempted to mitigate the cracking by only partially lithiating an electrode, but this can lead to inhomogeneous lithiation as some particles experience high local resistance and are not lithiated as intended, while other particles are fully lithiated and thereby degrade more rapidly.

Another attempt to reduce the effect of the Si expansion is by buffering it in composites in which grains of silicon are mixed with grains of metal, metal oxides, carbon or inert material. These systems can still suffer from the problem of Si migration, where the fully lithiated Si gathers into larger grains over time, creating the same problems as described above.

As an alternative to using pure silicon, a number of prior art documents propose other materials including silicon nitride. In many cases it is proposed to mix silicon compounds with metal nitrides into composite materials, although such a mixture should not be confused with actual silicon nitride material. Lithium nitride is known to be a good lithium conductor but is reported to be unstable in air due to hydrolysis by moisture present in ambient atmosphere.

WO 2017/207525 discloses a method for producing a powder of amorphous, micro-or nano-crystalline particles comprising silicon nitride (SiNₓ) in which the atomic ratio of silicon to nitrogen is in the range 1:0.2 to 1:0.9. The powder is produced by supplying reactant gases containing silicon and nitrogen to a reaction chamber, such as a Chemical Vapour Deposition (CVD) Free Space Reactor, and heating the reactant gases to a temperature that is sufficient for thermal decomposition or reduction of the reactant gases to take place inside the reaction chamber. The powder of particles may be used to produce an electrode for a battery. WO 2017/207525 discloses that, the inclusion of oxygen in the core region of the particles may be avoided or reduced to a minimum by carefully controlling the purity of the gases supplied to the reactor so that there may be no, or very little silicon oxide in an electrode produced from the particles, which is described as desirable. The skilled person is thereby taught not to intentionally add oxygen to the particles.

WO 2018/208111 discloses particles having a core with the chemical formula SiOx where 0≤x<2, i.e. a core of silicon (when x=0) or silicon oxide (when x>0), an intermediate layer containing silicon nitride, silicon oxynitride or a mixture thereof, and an outer carbon coating layer that includes carbon doped with nitrogen which covers at least part of the intermediate layer. However, these particles are not silicon oxynitride particles, as silicon oxynitride constitutes only a small part of the core/intermediate layer-combination.

### SUMMARY OF THE INVENTION

An object of the present invention is to provide an improved electrode that is suitable for an energy storage device, such as a battery, which comprises a powder of particles comprising amorphous, micro- or nano-crystalline non-stoichiometric silicon oxynitride and which mitigates of some of the degradation processes described above.

The powder of particles comprises coated or uncoated silicon oxynitride having a chemical formula SiNₓO_{y}, where 0.03≤x+y<1.3, whereby nitrogen makes up 10-99% of the x+y value with the balance being oxygen, i.e. the total value of x plus y is equal to or greater than 0.03 and less than 1.30. The particles namely comprise silicon and nitrogen and oxygen, and optionally other elements.

The inventors have found that an electrode comprising such a powder of particles, which contains more oxygen and less nitrogen than commercially available silicon nitride powder, works very well as an electrode material, especially when powders having particular particle sizes are used. The combination of the chemical composition with particle size provides the electrode material namely exhibits excellent cycle stability and a specific capacity that is better than the cycle stability and specific capacity of electrodes comprising a commercially available powder. Additionally, the storage capacity of an energy storage device comprising at least one such electrode can be substantially increased. Rather than taking steps to avoid or reduce the inclusion of oxygen in the particles constituting the powder, the inventors have found that it is advantageous to intentionally include oxygen in the particles. By using silicon oxynitride instead of carbon anodes in Li-ion batteries, or at least replacing part of the carbon-based anodes with the anodes based on silicon oxynitride, it has been shown that the storage capacity of the battery can be substantially increased.

According to an embodiment of the invention nitrogen makes up from 10%, 20%, 30%, 40%, 50% or 60%, 70% or 80% of the of x+y value, up to 40%, 50%, 60%, 70%, 80%, 90% or 99% of the x+y value.

According to an embodiment of the invention the electrode may comprise a powder of particles comprising SiNₓO_{y} particles having a maximum transverse dimension of 20 nm, 30 nm, 40 nm, 50 nm, 60 nm, 80 nm, or 90 nm, up to 100 nm, or up to 150 nm, in a coated or uncoated state. Such small SiNₓO_{y} particles, if used in a Li-ion battery, will improve the kinetics of lithiation of the active material therefore improving the battery performance. Alternatively, the powder of particles may comprise SiNₓO_{y} particles having a maximum transverse dimension of up to 10 μm in a coated or uncoated state, or less than 1 μm in a coated or uncoated state.

It should be noted that the SiNₓO_{y} particles described herein may comprise particles having a plurality of different shapes and the maximum transverse dimensions given in this document refer to the dimensions of single SiNₓO_{y} particles in their uncoated state or in their coated state in which the particles comprise a core region constituted by one or more SiNₓO_{y} particles and a shell region comprising one or more continuous or non-continuous shells.

According to an embodiment of the invention the SiNₓO_{y} particles can comprise up to 60 atomic-%, or up to 50 atomic-%, or up to 40 atomic-% or up to 30 atomic-% of one or more elements other than silicon and nitrogen and oxygen, i.e. up to 60 atomic-% of the uncoated SiNₓO_{y} particle in total, or up to 60 atomic-% of the core region in total when the SiNₓO_{y} particle is coated.

According to an embodiment of the invention oxygen and/or nitrogen atoms within the SiNₓO_{y} particles may be uniformly distributed through the entire electrode. Alternatively, there could be a concentration gradient of oxygen and/or nitrogen atoms within at least one part of the particle. The oxygen and/or nitrogen content within the particles may for example be independently arranged to increase or decrease with distance from a surface of the particle. Therefore, the SiNₓO_{y} represent a chemical composition of the whole particle. An electrode according to an embodiment of the invention may namely comprise a plurality of different types of silicon oxynitride particles having different chemical compositions.

Less than 1 atomic-%, or 0-10 atomic-%, or 0-20 atomic-%, or 0-30 atomic-%, or 0-40 atomic-%, or 0-50 atomic-% or 0-60 atomic-% of the nitrogen or silicon or oxygen atoms in the SiNₓO_{y} particles may namely be substituted with Li and/or one or more modifying elements as long as the powder of particles comprises silicon oxynitride having a chemical formula SiNₓO_{y}, where 0.03≤x+y<1.3, whereby nitrogen makes up 10-99%, or 20-80%, or 30-70% of the x+y value with the balance being oxygen. The SiNₓO_{y} particles may namely be fully lithiated for use with non-lithiated cathodes, such as in a Li-air or a Li—S battery.

According to an embodiment of the invention the amorphous or micro- or nano-crystalline, silicon oxynitride in the particles is modified with at least one of the following elements: phosphorus (P), boron (B), carbon (C), sulphur (S), selenium (Se), arsenic (As), tin (Sn), magnesium (Mg), aluminium (Al), iron (Fe), germanium (Ge) and/or antimony (Sb). By modifying the SiNₓO_{y} particles, both electron mobility and Li mobility can be improved when such modified SiNₓO_{y} particles are used to produce an anode for a Li-ion battery.

The presence of one or more modifying elements namely mitigates conductivity issues associated with high nitrogen content in the electrode material and provides more options regarding the particle size selection. More specifically, this allows for the preparation of relatively large SiNₓO_{y} particles without sacrificing the performance at initial cycles when a conductive electrode is being produced. In addition, the modification can be optimized to give the right band bending in the interface between a SiNₓO_{y} particle and an SEI-layer, so that no tunneling barrier is introduced.

A powder of SiNₓO_{y} particles may be produced using a method comprising the steps of supplying a reactant gas containing silicon, and a reactant gas containing nitrogen, and a reactant gas containing oxygen to a reaction chamber of a reactor and heating the reactant gases to a temperature sufficient for thermal decomposition or reduction of the reactant gases to take place inside the reaction chamber, whereby a powder of silicon oxynitride particles having a chemical formula SiNₓO_{y}, where 0.03≤x+y<1.3, whereby nitrogen makes up 10-99% of said x+y value with the balance being oxygen will be produced in the reactor.

Alternatively, a powder of SiNₓO_{y} particles may be produced using a method comprising the steps of supplying reactant gases containing silicon and nitrogen to a reaction chamber of a reactor, heating the reactant gas to a temperature sufficient for thermal decomposition or reduction of the reactant gases to take place inside the reaction chamber to thereby produce a powder of silicon nitride particles. The silicon nitride particles may then be exposed to oxygen or oxygen-containing gas to produce a powder of silicon oxynitride particles having a chemical formula SiNₓO_{y}, where 0.03≤x+y<1.3, whereby nitrogen makes up 10-99% of said x+y value with the balance being oxygen. The oxygen can namely be delivered through partial oxidation of the particle, through either exposure to air, oxygen, an oxygen-containing atmosphere or other oxidative environment in a liquid or gas phase.

Large quantities of such high purity amorphous, micro- or nano-crystalline, non-stoichiometric silicon oxynitride particles having a narrow size distribution (i.e. substantially monodisperse) may thereby be produced in a controlled manner. The method therefore provides a high yield of homogeneous particles whereby no extra step, such as filtering, is required to ensure that a desired standard deviation in size distribution is achieved.

Additionally, since the method results in the production of particles having a spherical or substantially spherical shape, the handling of the produced powder is facilitated. The expression “substantially spherical” refers to a degree of deviation from “spherical” that is sufficiently small so as to not measurably detract from the identified properties of the particles. Furthermore, if the silicon oxynitride particles are used in an energy storage device, such as for the anode of a Li-ion battery, SEI-layer formation and electrolyte consumption will be reduced due to the stability of the active material. The uniform size distribution contributes to better control in the charging and discharging of individual particles. In particular, during partial lithiation in normal operations, as opposed to the repeated full lithiation in typical lifetime testing, differences in particle size will result in differences in degradation. With large size variations, some particles will be fully lithiated while other particles are still far from saturated. Thus, the strain and degradation of the smallest particles will be unnecessarily large.

The chemical composition of the SiNₓO_{y} particles may be modified by supplying a reactant gas containing one or more of the modifying elements to the reaction chamber during the production of the SiNₓO_{y} particles and controlling the concentration and/or flow of the reactant gases so that less than 60 atomic-% of the nitrogen or silicon or oxygen atoms in the SiNₓO_{y} particles are substituted. The concentration of the modifying element in the SiNₓO_{y} may for example be up to 10 atomic percent, 1 atomic percent, 10 ppm, or up to 5 ppm or up to 1 ppm.

The method may be carried out in a Free Space Reactor using a Chemical Vapour Deposition (CVD) process. Chemical vapour deposition needs to be conducted inside a reaction chamber, but the deposition itself occurs favorably at silicon oxynitride or silicon nitride particle nucleation sites formed in the gas phase and not on the reactor walls. The powder formed has an amorphous, a micro- or nano-crystalline structure depending on operating conditions.

Apart from US patent application no. US 2015/280222, there seem to be very few, if any, prior art documents that specify any advantages of using amorphous silicon rather than crystalline silicon. The advantage of the amorphous silicon is that there is a multitude of diffusion paths available, and the clear two-phase behaviour seen in lithiation of crystalline silicon is removed.

The method may comprise the step of supplying at least one gas containing a metal, such as copper or iron, such as an organometallic precursor gas, to the reaction chamber of the reactor during the formation of the core region SiNₓO_{y} particles. Adding metal atoms to the core region in this way can improve the electrical conductivity of the particles and reduce cracking of the particles. The best results are obtained if the metal forms segregated networks in the particles, meaning that the metal content should be above the solubility limit of the metal in silicon.

The method may comprise the step of supplying at least one gas containing lithium to the reaction chamber of the reactor to at least partially lithiate the particles. The value of x+y may be tuned to the lithium-absorption capacity desired for a particular application, such as for an electrode, in which a trade-off between the conductivity of the particles, the lithium-absorption capacity of the particles, the expansion of the particles and the first cycle irreversible capacity of the particles has to be reached.

According to an embodiment of the invention the lithium content of the SiNₓO_{y} particles may be arranged to match the bulk irreversible lithiation capacity of the SiNₓO_{y} powder, which is a measure of the amount of lithium the SiNₓO_{y} powder can safely contain without being hazardous in production processes.

According to an embodiment of the invention the lithiated SiNₓO_{y} particles comprise up to 60 atomic-% lithium, or up to 50 atomic-%, or up to 40 atomic-% or up to 30 atomic-% lithium.

According to an embodiment of the invention, the x+y value is very small, namely 0.03≤x+y<0.3, or 0.03≤x+y<0.2, or 0.1≤x+y<0.3, or 0.1≤x+y<0.2.

According to an embodiment of the invention the powder of particles comprises aggregates of individual SiNₓO_{y} particles. According to an embodiment of the invention aggregates of individual particles have a minimum transverse dimension of 5 nm to 10 microns. It should be noted that while individual particles may be spherical, aggregated particles may have an irregular, non-spherical shape.

According to an embodiment of the invention the silicon oxynitride particles could be coated. The coated particles 30 may for example be used to produce an anode for an energy storage device, such as a Li-ion battery.

According to an embodiment of the invention the particles may be at least partially coated and have a core region comprising silicon oxynitride having a chemical formula SiNₓO_{y}, where 0.03≤x+y<1.3, whereby nitrogen makes up 10-99% of the x+y value with the balance being oxygen, and a shell region comprising at least one continuous or non-continuous shell comprising inorganic and/or organic material, such as at least one shell comprising at least one passivating material, such as carbon or silicon carbide or metal oxide. A coating step may be carried out inside the same reactor that is used for the production of the SiNₓO_{y} particles, or inside a different vessel.

According to an embodiment of the invention, the electrode comprises a binder and/or one or more conductive additives.

The present invention also concerns an energy storage device, such as a battery, which comprises at least one electrode, such as an anode, according to any of the embodiments of the invention.

According to an embodiment of the invention the battery is a Li-ion battery.

According to an embodiment of the invention the energy storage device comprises an electrolyte additive that enhances a first cycle lithiation of the SiNₓO_{y} particles, by providing a surface electrolyte interface (SEI) layer that facilitates the lithiation of the SiNₓO_{y} particles. The electrolyte additive may be at least one of the following: fluoroethylene carbonate (FEC), vinylene carbonate (VC).

According to another embodiment of the invention the energy storage device comprises an electrolyte additive that enhances a first cycle Coulombic efficiency of the SiNxOy, by providing an additional source of lithium that is arranged to be incorporated into the material during cycling.

In one embodiment of the invention, an electrolyte additive acting as a surfactant forms an SEI-layer aiding the Li insertion. Fluoroethylene carbonate (FEC) is used in pure silicon anodes to prevent cracking and degradation. The inventors propose to use FEC to form an intermediate layer where the electrochemical transition from Li↔Li+ +e− can occur.

Alternatively, the electrolyte could be represented by ionic liquids, polymer electrolytes, gel-polymer electrolytes, glass or ceramic electrolytes or a combination of thereof.

An initial lithiation of the SiNₓO_{y} particles will leave lithium trapped both in certain states in the bulk of the material (hereafter will be referred to as the ‘bulk irreversible capacity’), and at the surface of the particles (hereafter referred to as the ‘surface irreversible capacity’). Increasing particle size will allow a reduction of the irreversible capacity related to the surface reaction. The bulk trapping of lithium is directly related to the amount of nitrogen and oxygen in the particles, and, by reducing the nitrogen content in the particles, first cycle irreversible capacity is reduced, while the cycling stability is increased.

Due to the band gap and low electrical conductivity of pure stoichiometric silicon nitride, it could be difficult to achieve the initial lithiation of pure stoichiometric silicon nitride particles when these particles are to be used in a Li-ion battery. Three innovations are proposed by the inventors to mitigate this. Firstly, it is suggested to keep the concentration of nitrogen and also oxygen low within the particle, i.e. much lower than the atomic concentration of silicon, to improve conductivity. Secondly, it is proposed that the powder should have an amorphous, micro- or nano-crystalline structure, to improve lithiation homogeneity and reduce the stresses in the particles during lithiation. Thirdly, it is proposed to form an intermediate layer on the particle surface where the electrochemical transition from Li↔Li+ +e− can occur outside the SiNₓO_{y} before the lithium diffuses into the SiNₓO_{y} particles, reducing the importance of the electric conductivity of the nitride.

Pre-lithiating the particles by supplying at least one gas containing lithium to the reaction chamber of the reactor will improve battery performance if the particles are used in a battery, such as a Li-ion battery. Including lithium in the particle before submersing the particles in electrolyte is namely advantageous since it reduces electrolyte consumption during initial battery cycles, and reduces the need for time-consuming battery formation cycling for stabilization in a factory to obtain an equilibrium condition prior to the use of the battery. Also, a coating can then be formed on the particle while the particle has a size closer to the average size it will have in operations, reducing strain in the SEI-layer.

Furthermore, since lithium-silicon mixtures/alloys are initially amorphous (with a few exceptions), the amorphous, micro- or nano-crystalline nature of coated particles is likely to speed up the kinetics of lithiation. It is more difficult for cracks to propagate through amorphous material, and the internal strain between different regions of the powder with different lithium contents will be lower if all areas are amorphous, or at least microcrystalline or nanocrystalline.

The method may comprise the step of pre-heating the reactant gases to a temperature below the reaction temperature, i.e. within 10° C., 20° C., 30° C., 40° C., 50° C., 60° C., 70° C., 80° C., 90° or 100° C. of the reaction temperature before the reactant gases are supplied to the reaction chamber of the reactor. This has been found to improve size control, probably as it results in providing a more homogeneous temperature in the reaction chamber and in the production of SiNₓO_{y} particles having a very narrow particle size distribution.

The silicon-containing reactant gas may comprise at least one of the following: silane having a chemical structure of SiₙH₂ₙ₊₂ where n is an integer number, a chlorosilane, dichlorosilane, trichlorosilane, and/or halide-substituted silanes having a chemical structure of SiₙH_{2n+2-y}Hal_{y}, or alkyl silanes. The nitrogen-containing reactant gas may comprise at least one of the following: ammonia, nitrogen. The oxygen-containing reactant gas may comprise at least one of the following: oxygen gas, water vapor or nitrogen oxide.

It should be noted that the expression “reactant gas” as used in this document need not necessarily mean that a reactant gas comprises just one gas. A reactant gas may comprise one or more silicon- or nitrogen- or oxygen-containing gases and even one or more other gases, such as a catalyst gas or a modifying gas.

At least one wall of the reaction chamber may be at least partly constituted by a porous membrane and said method comprises the step of supplying a primary gas through the porous membrane to provide a protective inert gas boundary at said at least one wall of the reaction chamber to minimize or prevent the deposition of produced particles on the porous membrane while the reactor is use. This is especially interesting for industrial scale production.

The method may comprise the step of collecting the produced particles using at least one of the following a filter, gravitational separation, electrostatic forces.

The method may also comprise heat treating the particles after their production, in an oxygen-free atmosphere, such as an inert atmosphere or hydrogen-containing atmosphere. Alternatively, the method may comprise the step of exposing the produced particles to an oxygen-containing atmosphere at room or elevated temperature to provide the particles with a SiNₓO_{y} composition and possibly add stoichiometric or non-stoichiometric oxide shell.

The powder of particles produced by the method contains a large amount of silicon as compared to stoichiometric Si₃N₄. By carrying out this optional post-processing step after the particle formation process, nano-domains of silicon will start to precipitate. If enough silicon is available, the nano-domains will be linked together in a 3D-network. Substantially all of the silicon surfaces will then be protected by a near stoichiometric SiNₓ matrix. This is very similar to the well-known process of formation of Silicon quantum dots in solar cells devices. The post-production heat treatment step facilitates the production of powder that is homogenous on a length scale of >10 nm or on a length scale of >2 nm, while creating a self-assembled nanostructure (i.e. nano-domains) on shorter length scales. The post processing heat treating step may be conducted in-line with the particle formation method or as a separate batch processing step. The heat treatment may be conducted using Infra-Red (IR) or standard resistance heating means. Furthermore, the post-production heat treatment step drives hydrogen out of the produced particles and reorganizes the particles. Similar process may occur during initial lithiation step, leading to a formation of Si nano-domains in a matrix comprised of Li, Si, N and possibly O.

The method may comprise the step of at least partially coating the amorphous, micro- or nano-crystalline non-stoichiometric silicon oxynitride particles with at least one organic or inorganic material, to obtain a powder of coated particles comprising a core region and a shell region comprising at least one continuous or non-continuous shell. The shell could be further carbonized at elevated temperature and inert atmosphere to provide carbon coated particles. Alternatively, the particles may be coated with metal oxides, such as titanium or zirconium oxides, which could be deposited through ALD or solution-based chemistry.

According to an embodiment of the invention the SiNₓO_{y} particles have an outer surface that is free from irregularities, roughness and projections when viewed at a maximum resolution of a Scanning Electron Microscope (SEM), i.e. a spatial resolution less than 100 nm. Cracks in Si particles have namely been shown to be initiated from irregularities in the particle surface. The cracks then propagate along grain boundaries, or along preferred crystal orientations. By having particle with a smooth, amorphous, micro- or nano-crystalline outer surface and preferably a substantially spherical shape, the likelihood of producing suitable nucleation points for cracks is substantially reduced, thereby delaying cracking tendency, or increasing the particle size fluctuation that can be allowed before cracks are induced.
The present invention also concerns a method for producing an electrode according to any of the embodiments of the invention. The electrode is fabricated using slurry-based processing. The method comprises the steps of mixing a powder of particles comprising coated or uncoated silicon oxynitride having a chemical formula SiNₓO_{y}, where 0.03≤x+y<1.3, whereby nitrogen makes up 10-99% of said x+y value with the balance being oxygen, with a binder, optionally one or more additives, such as one or more electrically conductive additives, and a solvent, such as water, with or without pH adjustments to make a mixture, and printing or coating the mixture on a surface of a current collector and drying to form an electrode.

### Definitions

An electrical energy storage device is any apparatus used for storing electrical energy that utilizes a reduction/oxidation reaction to convert electrical energy into chemical energy during charging and, conversely, chemical energy to electrical energy during discharging.

The electrode of an electrical energy storage device comprises a current collector which is usually constituted by a metal foil, such as a copper foil, an aluminum foil, or stainless-steel foil, and an electrode active material layer coated on a surface of the current collector. An electrode is the final product after an electrode active material comprising SiNₓO_{y} particles with or without binder and conductive additive(s) has been applied to a current collector and dried and is ready for assembly in an energy storage device.

Of the electrodes in an electrochemical system, an anode is defined as an electrode on which an oxidation reaction happens, while a cathode is defined as an electrode on which a reduction reaction happens. For an electrochemical cell, the designations of the two electrodes change depending on whether the cell is charged or discharged; however, normal convention in battery technology is to designate the electrodes based on their function during discharge, as is used in the context of this document. Within the present document, anode refers to an electrode where oxidation of lithium occurs.

A current collector is used as an electron transfer channel for electrons released in the electrochemical reactions of the electrical energy storage device to an external circuit to provide current. A current collector may also be called a “substrate”.

A binder is a material or substance that holds other materials together to form a cohesive whole by mechanical or chemical means. In a battery this entails holding the electrode material particles together, as well as holding this to the current collector.

Conductive additives are materials that are added to the electrodes to improve and maintain the electrical conductivity within the electrode, ensuring the necessary electrical connection between the active material particles and the current collector for the battery to function.

An active material in the context of the present document is a material that is directly involved in the electrochemical reaction itself, which results in energy release or storage. This is in contrast to passive materials which play a secondary role in the functioning of the device, e.g. binder and conductive additives, whose primary roles are to maintain the mechanical and electrical integrity of the electrodes, respectively.

In the present document, the electrode active material is represented by SiNₓO_{y} particles coated/printed on a surface of a current collector. The expression “electrode active material” does not namely include the current collector of an electrode.

An amorphous material is a solid material in which the positions of the atoms do not exhibit the property of long-range order, often termed translational periodicity, in contrast to a crystalline solid in which atomic positions exhibit this property.

Chemical vapour deposition (CVD) is parent to a family of processes whereby a solid material is deposited from a vapour by a chemical reaction occurring on or in the vicinity of a normally heated substrate surface. The resulting solid material is in the form of a thin film, powder, or single crystal.

Aggregates, in the context of this document, relate to SiNₓO_{y} particles that themselves are comprised of a number of smaller primary SiNₓO_{y} particles bound together by chemical or mechanical means, together forming a whole.

A nanomaterial is a natural, incidental or manufactured material containing particles, in an unbound state or as an aggregate or as an agglomerate and where, for 50% or more of the particles in the number size distribution, one or more external dimensions is in the size range 1 nm-100 nm.

The Solid Electrolyte Interphase (SEI) is a passivating layer that forms on the surface of electrode materials as a consequence of electrolyte constituents decomposing at electrochemical potentials present at the electrodes. The layer consists primarily of electrolyte and Li salts decomposition products and plays a vital role in the stable operation of primarily Li-ion batteries.

A current collector is used as an electron transfer channel for electrons formed in the electrochemical reactions of the electrical energy storage device to an external circuit to provide current. A current collector may also be called a “substrate”.

### BRIEF DESCRIPTION OF THE DRAWINGS

The present invention will hereinafter be further explained by means of non-limiting examples with reference to the appended schematic figures where;

FIG. 1 shows a device for producing SiNₓO_{y} particles,

FIG. 2 shows a coated SiNₓO_{y} particle,

FIG. 3 shows an electrical energy storage device, namely a battery comprising an electrode according to an embodiment of the invention and electrolyte,

FIG. 4 is a flow chart showing the steps of a method described herein, and

FIGS. 5-7 show microscopy images of SiNₓO_{y} particles according to embodiments of the invention.

It should be noted that the drawings have not necessarily been drawn to scale and that the dimensions of certain features may have been exaggerated for the sake of clarity.

### DETAILED DESCRIPTION OF EMBODIMENTS

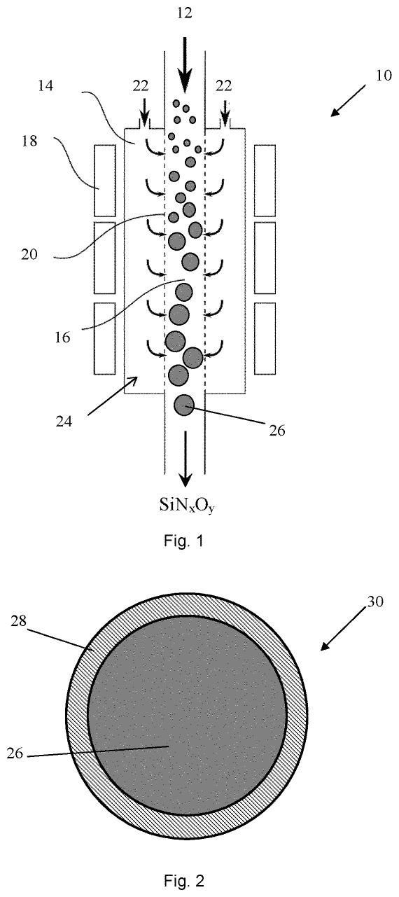

FIG. 1 shows a device 10 for producing a powder comprising amorphous, micro- or nano-crystalline silicon oxynitride particles having a chemical formula SiNₓO_{y}, where 0.03≤x+y<1.3, whereby nitrogen makes up 10-99% of said x+y value with the balance being oxygen by homogeneous thermal decomposition or reduction of reactant gases 12 containing silicon and nitrogen and oxygen.

The embodiment illustrated with reference to FIG. 1 involves the production of SiNₓO_{y} in the device 10. The device 10 may however alternatively be used to produce silicon nitride particles that do not contain the oxygen, whereby a reactant gas containing oxygen is not supplied to the device 10 during the production of the silicon nitride particles. Instead, the produced silicon nitride particles are subsequently exposed to an oxygen-containing atmosphere to produce a powder of silicon oxynitride particles having a chemical formula SiNₓO_{y}, where 0.03≤x+y<1.3, whereby nitrogen makes up 10-99% of said x+y value with the balance being oxygen.

The device 10 comprises a reactor 14 having a reaction chamber 16 with one or more inlets for the reactant gases 12, located at the top of the device 10 for example to obtain a descending reactant gas flow. The reactor 14 may be a Free Space Reactor having stainless steel, silicon carbide or quartz walls for example, which is arranged to decompose the reactant gas 12 homogeneously in the gas phase and thus to grow the desired SiNₓO_{y} particles. Volatile by-products may be removed by gas flow through the reaction chamber 16.

Contrary to a multi-stage reactor, such as the one disclosed in U.S. Pat. No. 4,314,525, in the device 10, no seed particles are introduced into the reactor 14. Furthermore, particles are not grown on a substrate, such as a hot substrate or deposited on a wafer, such as a heated wafer, and no salt is used to produce the particles. In the method, deposition is carried out on particles floating in heated gas.

The device 10 also comprises means 18, such as heating coils, which are located around the outer wall of the reactor 14 in the illustrated embodiment, to heat the reactant gases 12 to a temperature sufficient for thermal decomposition or reduction of the reactant gases 12 to take place inside the reaction chamber 16. The reactant gases 12 are preferably pre-heated to a temperature that is just below the reaction temperature and then, when the reactant gases are in the reaction chamber 16, the temperature inside the reactor 10 provides the energy required so that the particles start forming. This produces particles with a narrow size distribution.

The reaction chamber 16 in the illustrated embodiment is constituted by a single wall constituted entirely by a porous membrane 20, such as a substantially cylindrical tube of material of suitable mechanical and chemical properties. It should be noted that the porous membrane 20 may be of any suitable shape, it may for example be in the form of an upright or inverted cone.

The device 10 may optionally comprise one or more inlets that are arranged to supply a primary gas 22, such as hydrogen or argon, through the porous membrane 20 to provide a protective inert gas boundary at the wall of the reaction chamber 16 to minimize or prevent the deposition of the material on the porous membrane 20 when the device 10 is in use. The one or more inlets may optionally also be used to supply a secondary gas through the porous membrane 20 to influence the thermal decomposition or reduction of the reactant gas 12 inside the reaction chamber 16. The expression “influence the thermal decomposition or reduction of the reactant gas inside the reaction chamber” as used in this document is intended to mean slow down, speed up, prevent, start, modify or change one or more chemical reactions taking place inside the reaction chamber 16. It is not however necessary for a reactor in which a method is carried out to comprise a porous membrane 20.

A silicon-containing reactant gas 12, such as monosilane (SiH₄), which might or might not be diluted in hydrogen or with other gases such as Ar, may be supplied to the reaction chamber 16. Means 18 for heating the reaction chamber 16 raises the temperature of the silicon-containing reactant gas 12 to a point of thermal decomposition whereby the following reaction takes place and elemental silicon, is formed:

SiH₄→Si+2H₂

For monosilane this temperature is 400° C., however, for growth control the temperature of pyrolysis could be above this value. The reactant gas 12 may also contain one or more modifying gases, such as arsine, diborane, phosphine, boron trifluoride, trimethylboron or any other metal/organic/inorganic modifying gas, which may for example be added in the particles' nucleation and/or growth phase(s). The reactant gas 12 may for example contain a metal or lithium-containing gas, which is supplied during the particle nucleation phase, and/or after the particle nucleation phase. It should be noted that a modifying gas may additionally or alternatively be supplied through the porous membrane 20 in the illustrated embodiment.

Primary gas 22, such as hydrogen, nitrogen or argon is supplied to a chamber 24 outside the reaction chamber 16 that is delimited by the porous membrane wall 20. The reactor 14 is thereby divided into an outer chamber 24 for primary gas 22 and an inner reaction chamber 16 where a decomposition or reduction reaction takes places at a distance from the wall(s) of the reaction chamber 16. The primary gas 22 in the outer chamber 24 is namely arranged to pass through the porous membrane 20 from the outer chamber 24 to the near wall region of the reaction chamber 16. When the primary gas 22 enters the reaction chamber 16, the near wall region will be kept free of reactant gas 12 and thus unwanted wall depositions will be avoided.

Secondary gas may also be supplied to the chamber 24 outside the reaction chamber 16 that is delimited by the porous membrane wall 20. The secondary gas may be added in the particles' nucleation and/or growth phase(s). The secondary gas may for example contain a metal- or lithium-containing gas, which is supplied through the porous membrane during the particle nucleation phase, and/or after the particle nucleation phase but prior to their exposure to air.

Depending on the operation temperature and requirements for the finished product, the porous membrane 20 may comprise a metal alloy such as AISI316, Inconel, 253MA or HT800. The membrane may also be produced from porous sintered silicon-nitride Si₃N₄, porous silica SiO₂, porous alumina Al₂O₃, graphite or any other suitable material.

It should be noted that the reaction chamber 16 dimensions may vary from having a maximum transverse dimension of a few millimetres to a few metres.

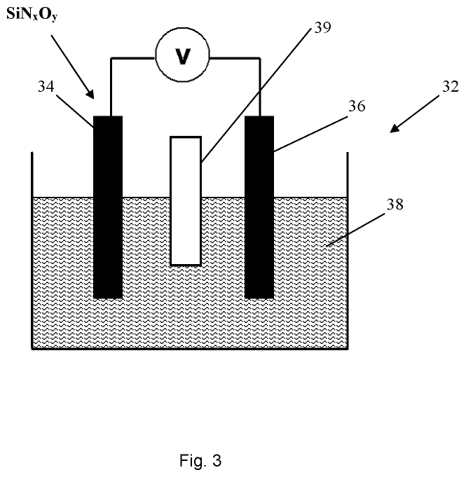

The thermal decomposition or reduction of the reactant gases 12 inside the reaction chamber 16 is controlled so as to produce a powder of SiNₓO_{y} particles which may subsequently form a core region 26 of a coated particle 30 as schematically shown in FIG. 2. The thermal decomposition or reduction of the reactant gases 12 inside the reaction chamber 16 may for example be controlled by adjusting the temperature, pressure, flow rate, heat capacity and/or composition, of the reactant gases 12 (and/or a reaction-influencing gas).

FIG. 2 shows a coated SiNₓO_{y} particle 30 comprising a core region 26 and a shell region 26 comprising one continuous shell. An electrode according to the present invention may comprise continuously or non-continuously coated SiNₓO_{y} particles 30 or a mixture of continuously and/or non-continuously coated, and uncoated SiNₓO_{y} particles. The coated particles 30 may be substantially spherical and may have a core region 26 that is substantially spherical.

The SiNₓO_{y} particles comprise coated or uncoated silicon oxynitride having a chemical formula SiNₓO_{y}, where 0.03≤x+y<1.3, whereby nitrogen makes up 10-99% of said x+y value with the balance being oxygen. Different SiNₓO_{y} chemical compositions can be achieved by varying the ratio of the precursor gases. The chemical composition of the SiNₓO_{y} particles may be determined using energy-dispersive spectroscopy (EDS) and electron energy loss spectroscopy (EELS) analysis, for example.

An electrode according to the present invention may comprise aggregate of individual SiNxOy particles whereby each SiNₓO_{y} particle comprises at least one continuous or non-continuous shell region 28, or whereby a plurality of SiNₓO_{y} particles comprise at least one common continuous or non-continuous shell 28. The at least one continuous or non-continuous shell 28 may comprise one or more organic and/or inorganic materials. The at least one shell 28 may contain carbon.

A shell region 28 may comprise 3-100 monolayers of organic and/or inorganic material so as to be thin but mechanically robust.

The thermal decomposition or reduction of the reactant gases 12 inside the reaction chamber may be influenced by changing at least one of the following characteristics of the reactant gas and/or reaction-influencing gas: temperature, pressure, flow rate, heat capacity, composition, modifying element type(s) and/or amount(s), catalyst type(s) and/or amount(s), and/or concentration of one or more components of said gases. By changing at least one of the characteristics of the reactant gases and/or reaction-influencing gas, the thermal decomposition or reduction of the reactant gas inside the reaction chamber, and consequently the formation and/or growth of particles, and/or their morphology and/or crystallinity, may be controlled in order to obtain a final product having the desired characteristics.

For example, the temperature of the primary gas and/or secondary gas may be increased once particles have been formed in order to produce crystalline material. Alternatively, the temperature of the primary gas and/or secondary gas may be decreased to produce amorphous material. The amount of hydrogen in the primary gas and/or secondary gas may be increased to decrease the production of nuclei and thereby the total number of particles. The flow rate of the primary gas and/or secondary gas may be increased to promote turbulence inside the reaction chamber, or decreased to reduce turbulence, depending on which conditions are conducive to the production of the desired product.

The primary gas and/or secondary gas preferably has/have a high heat capacity to help provide uniform heating within the reaction chamber. This may however vary with the application since several decomposition reactions include intermediate reversible stages, whereby it may be advantageous to promote particle growth over particle formation. Such stages may be temperature dependent, and in such cases a controlled uneven temperature distribution is favourable.

The secondary gas may be supplied through the porous membrane simultaneously with the primary gas, periodically, continuously, intermittently, when desired, or in any combination of these ways during the use of a reactor. The primary gas and the secondary gas may be arranged to be supplied through the same pores, or through different pores in the porous membrane.

It should also be noted that the expressions “primary gas” and “secondary gas” as used in this document need not necessarily mean that said gases comprise just one type of gas.

A primary gas and/or a secondary gas may also comprise at least one catalyst gas. Furthermore, different primary gases and/or secondary gases may be used during the use of a reactor.

The actual dimensions of the components of the device 10 (such as the diameter or length of the reaction chamber tube or the shape of the reactor chamber) are not especially critical. In addition, operating parameters such as gas flow rates and operating temperatures can be established experimentally for different devices having different sizes and configurations.

The particles could be exposed to another gas contain modifying elements (such as oxygen and others) prior to the collection.

The method may be used to produce a high volume of powder of SiNₓO_{y} particles. The method is easy to scale up and it is possible to achieve continuous particle production while the reactor is in use.

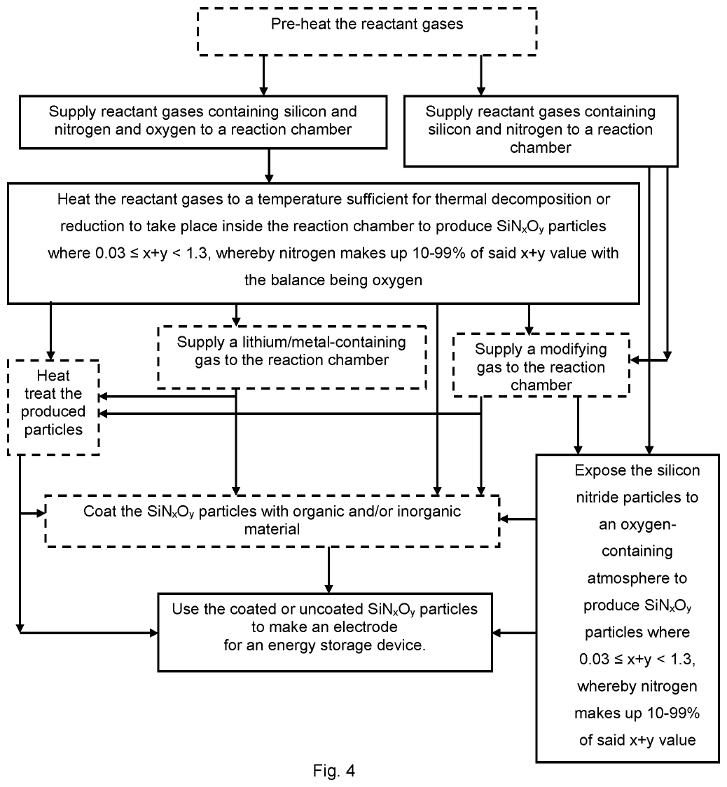

FIG. 3 shows an energy storage device 32, namely a battery comprising an electrode 34 according to an embodiment of the invention, which constitutes an anode of the energy storage device 32. The energy storage device 32 also comprises a cathode 36 and electrolyte 38, which may be liquid, solid or a gel. Optionally, an electrical energy storage device according to the present invention may contain a separator 39.

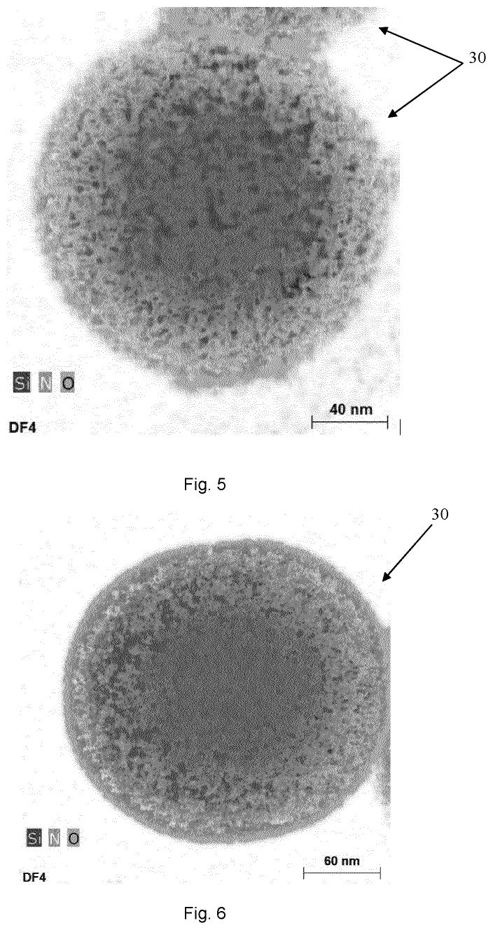

FIG. 4 is a flow chart showing the steps of a method described herein. The method comprises the steps of supplying reactant gases containing silicon and nitrogen and oxygen to a reaction chamber of a reactor, heating the reactant gas to a temperature sufficient for thermal decomposition or reduction of the reactant gases to take place inside the reaction chamber to thereby produce a powder of particles comprising silicon oxynitride having a chemical formula SiNₓO_{y}, where 0.03≤x+y<1.3, whereby nitrogen makes up 10-99% of said x+y value with the balance being oxygen.

Alternatively, the method may comprise the steps of supplying reactant gases containing silicon and nitrogen to a reaction chamber of a reactor, heating the reactant gas to a temperature sufficient for thermal decomposition or reduction of the reactant gases to take place inside the reaction chamber to thereby produce a powder of silicon nitride particles.

The silicon nitride particles may then be exposed to an oxygen-containing atmosphere to produce a powder of silicon oxynitride particles having a chemical formula SiNₓO_{y}, where 0.03≤x+y<1.3, whereby nitrogen makes up 10-99% of said x+y value with the balance being oxygen.

Optionally, either of these two methods may also comprise one or more of the following steps (which have been illustrated in dashed boxes in FIG. 4): supplying at least one gas containing a metal, such as lithium to the reaction chamber of the reactor, supplying at least one modifying gas to said reaction chamber of said reactor to modify the particles, coating the SiNₓO_{y} particles or silicon nitride particles with passivating material in the reaction chamber or in a different vessel, using the coated or uncoated SiNₓO_{y} particles to produce an electrode for an energy storage device, such as a Li-ion battery.

It should be noted that the steps of supplying reactant gases containing silicon and nitrogen and oxygen to a reaction chamber of a reactor, supplying at least one gas containing a metal, such as lithium to the reaction chamber of the reactor and supplying at least one modifying gas to said reaction chamber of said reactor to modify the particles do not have to be carried out in a particular sequence. An inert gas boundary is preferably, but not necessarily established before reactant gases and/or a secondary gas are supplied to the reaction chamber.

The method may also comprise at least one of the optional steps of pre-heating the reactant gases to a temperature below the reaction temperature before the reactant gases are supplied to the reaction chamber of the reactor and/or heat treating the particles after their production, in an oxygen-free atmosphere, such as an inert atmosphere or hydrogen-containing atmosphere. Alternatively, the method may comprise the step of exposing the produced particles to an oxygen-containing atmosphere or environment to provide SiNₓO_{y} particles which can optionally have a stochiometric or non-stochiometric silicon oxide shell.

The post-production heat treatment step may be carried out at a temperature of 600-1300° C. with a process time within 2-3600 seconds in the inert or hydrogen-containing atmosphere.

The post-production step may be carried out at the temperatures of 25-1300° C. with a process time within 2-3600 seconds in the oxygen-containing atmosphere.

An electrode may be fabricated using slurry-based processing in which the produced SiNₓO_{y} particles are mixed with a binder, optionally one or more additives, such as an electrically conductive additive, and a solvent, such as water, with or without pH adjustments, printed or coated on a surface of a current collector and dried to form an electrode.

The solids used for slurry preparation may comprise at least 2 weight-%, at least 5 weight-%, at least 10 weight-%, at least 20 weight-% , at least 30 weight-%, at least 40 weight-%, at least 50 weight-% or at least 60 weight-% of the SiNₓO_{y} particles.

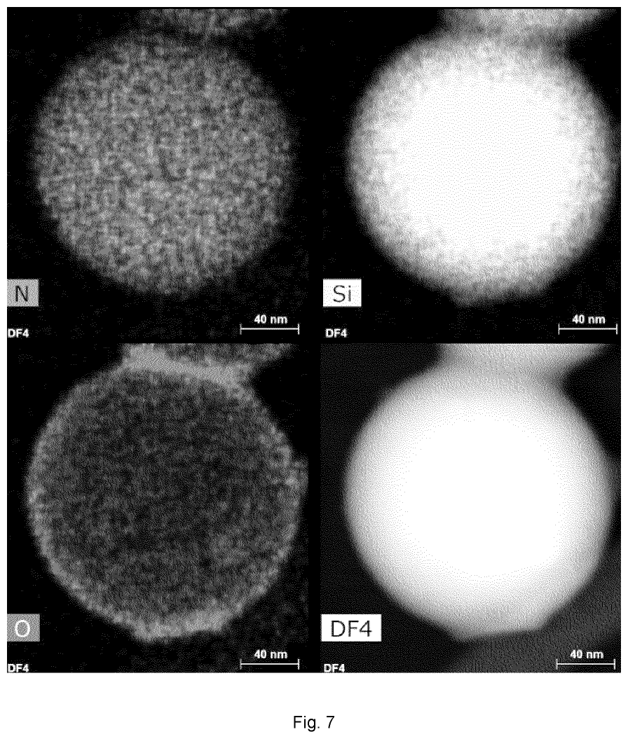

FIG. 5 shows a scanning transmission electron microscopy (STEM) image taken using a 4-quadrant dark field (DF4) detector that detects the small fraction of electrons that are scattered outside of the bright field (BF) region, to the dark field (DF) region. The image shows the distribution of silicon, nitrogen and oxygen atoms in an uncoated silicon oxynitride particle according to an embodiment of the invention. The silicon oxynitride particle has a chemical formula SiN_{0.54}O_{0.1} whereby x=0.54, y=0.1, and x+y=0.64. The atomic composition of the particle is 61% silicon, 33% nitrogen and 6% oxygen. Oxygen atoms are visible as a halo around the particle in the microscopy image. The silicon oxynitride particle is attached to another silicon oxynitride particle that is visible in the top right-hand corner of the image.

FIG. 6 shows a STEM image taken using a DF4 detector of another uncoated silicon oxynitride particle having the same chemical composition as the particle shown in FIG. 5. The silicon oxynitride particle is attached to another silicon oxynitride particle that is just visible on the right-hand side of the image.

FIG. 7 shows three STEM images which each show the distribution of either silicon, nitrogen or oxygen atoms in the uncoated silicon oxynitride particle shown in FIG. 5. The fourth image is taken using a DF4 detector.

Further modifications of the invention within the scope of the claims would be apparent to a skilled person.

1. Electrode (34) for an energy storage device (32) which comprises a powder of particles (26) comprising amorphous, micro- or nano-crystalline silicon oxynitride, characterized in that said powder of particles (26) comprises coated or uncoated silicon oxynitride having a chemical formula SiNₓO_{y}, where 0.03≤x+y<1.3, whereby nitrogen makes up 10-99% of said x+y value with the balance being oxygen.

2. Electrode (34) according to claim 1, characterized in that 0.03≤x+y<0.3, or 0.03≤x+y<0.2, or 0.1≤x+y<0.3, or 0.1≤x+y<0.2.

3. Electrode (34) according to claim 1 or 2, characterized in that said SiNₓO_{y} particles (26) have a maximum transverse dimension of 150 nm in a coated or uncoated state.

4. Electrode (34) according to claim 1 or 2, characterized in that said SiNₓO_{y} particles (26) have a maximum transverse dimension of up to 10 μm in a coated or uncoated state.

5. Electrode (34) according to any of the preceding claims, characterized in that the SiNₓO_{y} particles comprise 0-60 atomic-% of one or more elements other than silicon and nitrogen and oxygen.

6. Electrode (34) according to any of the preceding claims, characterized in that said SiNₓO_{y} particles (26) have a lithium content in the range of 0 to 60 atomic-%.

7. Electrode (34) according to any of the preceding claims, characterized in that said SiNₓO_{y} particles (26) contain at least one of the following modifying elements: phosphorus (P), boron (B), carbon (C), sulphur (S), selenium (Se), arsenic (As), tin (Sn), magnesium (Mg), aluminium (Al), iron (Fe), germanium (Ge) and/or antimony (Sb).

8. Electrode (34) according to any of the preceding claims, characterized in that said powder of particles comprises aggregates of individual SiNₓO_{y} particles.

9. Electrode (34) according to any of the preceding claims, characterized in that said SiNₓO_{y} particles (26) are at least partially coated and have a core region comprising silicon oxynitride having a chemical formula SiNₓO_{y}, where 0.03≤x+y<1.3, whereby nitrogen makes up 10-99% of said x+y value with the balance being oxygen, and at least one continuous or non-continuous shell region (28) comprising inorganic and/or organic material.

10. Electrode (3) according to any of the preceding claims, characterized in that it comprises a binder and/or one or more conductive additives.

11. Energy storage device (32), characterized in that it comprises at least one electrode (34) according to any of the preceding claims.

12. Energy storage device (32) according to claim 11, characterized in that it is a battery, such as a Li-ion battery.

13. Energy storage device (32) according to claim 11 or 12, characterized in that it comprises an electrolyte additive that enhances a first cycle lithiation of said SiNₓO_{y} particles (26), by providing a surface electrolyte interface (SEI) layer that facilitates the lithiation of SiNₓO_{y} particles (26).

14. Energy storage device according to claim 13, characterized in that said electrolyte additive is at least one of the following: fluoroethylene carbonate (FEC), vinylene carbonate (VC).

15. Energy storage device (32) according to claim 11 or 12, characterized in that it comprises an electrolyte additive that enhances a first cycle Coulombic efficiency of said SiNxOy (26), by providing an additional source of lithium that is arranged to be incorporated into the material during cycling.

16. Method for producing an electrode (34) according to any of claims 1-10, characterized in that it comprises the steps of mixing a powder of particles (26) comprising coated or uncoated silicon oxynitride having a chemical formula SiNₓO_{y}, where 0.03≤x+y<1.3, whereby nitrogen makes up 10-99% of said x+y value with the balance being oxygen, with a binder, optionally one or more additives, such as one or more electrically conductive additives, and a solvent, such as water, with or without pH adjustments, and printing or coating said mixture on a surface of a current collector and drying to form an electrode (34).
